(19) United States
(12) Patent Application Publication
(10) Pub. No.: US 2018/0372204 A1
(43) Pub. Date: Dec. 27, 2018

(54) Differential Bearing Arrangement For Mounting A Differential Cage

(71) Applicant: ZF FRIEDRICHSHAFEN AG, Friedrichshafen (DE)

(72) Inventors: Rainer HILDEBRAND, Friedrichshafen (DE); Paul LENZ, Waldkirchen (DE); Peter HASELBERGER, Mauth (DE); Horst SIGL, Tiefenbach (DE); Manuel BAUER, Tittling (DE); Stefan BRACHMEIER, Geisenhausen (DE)

(21) Appl. No.: 16/060,845

(22) PCT Filed: Nov. 15, 2016
(86) PCT No.: PCT/EP2016/077638

§ 371 Date: Jun. 8, 2018

(30) Foreign Application Priority Data
Dec. 15, 2015 (DE) 10 2015 225 280.9

(51) Int. Cl. F16H 48/40

(52) U.S. Cl. CPC F16H 48/40; F16H 2048/405

(57) ABSTRACT

A differential bearing arrangement is provided for supporting a differential cage, having a final drive housing, at least one bearing support and at least one fastening screw with a screw head and a cylindrical screw body that is provided with an external thread and fixedly connects the bearing support to the final drive housing. The bearing support has a blind hole with an internal thread and the fastening screw is arranged such that the screw head thereof comes to bear against an outer surface of the final drive housing, and the screw body extends through a through-recess formed in the final drive housing and is at least partially received by the blind hole formed in the bearing support. The internal thread of the blind hole cooperates with the external thread of the fastening screw.

### CROSS REFERENCE TO RELATED APPLICATIONS

This is a U.S. national stage of application No. PCT/EP2016/077638, filed on Nov. 15, 2016. Priority is claimed on German Application No. DE102015225280.9, filed Dec. 15, 2015, the content of which is incorporated here by reference.

### BACKGROUND OF THE INVENTION

### 1. Field of the Invention

The invention is directed to a differential bearing arrangement for supporting a differential cage.

### 2. Description of the Prior Art

A generic differential bearing arrangement is known from DE 2006 012 342 A1. It comprises a final drive housing with a first portion and a second portion that are separated from one another by a fastening collar for fastening the final drive housing to an axle bracket of a vehicle axle. At least one bearing support, which receives the differential cage at least indirectly, is arranged at the first portion of the final drive housing. The bearing support is fixedly connected to the final drive housing by at least one fastening screw. The connection of the bearing support to the final drive housing is typically carried out such that the screw head of the fastening screw abuts the bearing support and a cylindrical screw body of the fastening screw is guided through a through-bore formed in the bearing support and engages in a bore which is made in the drive housing and provided with a thread.

A fastening of this kind has the disadvantage that corresponding installation space must be reserved inside the axle bracket for the screw head and mounting tool and the existing installation space cannot be optimally exploited. In order to ensure this installation space, the axle bracket must be correspondingly large, as a result of which more material is consumed and the total weight of the axle bracket is accordingly high.

### SUMMARY OF THE INVENTION

It is an object of one aspect of the present invention to provide a differential bearing arrangement for supporting a differential cage that makes better use of the installation space.

Accordingly, the bearing support of the differential bearing arrangement according to one aspect of the invention has a blind hole with an internal thread formed therein. The fastening screw is arranged such that the screw head thereof comes to bear against an outer surface of the second portion of the final drive housing, and the screw body extends through a through-recess formed in the final drive housing and which connects the first portion to the second portion of the drive housing and is at least partially received by the blind hole formed in the bearing support, and the internal thread of the blind hole cooperates with the external thread of the fastening screw.

According to a first advantageous constructional variant, the differential bearing arrangement comprises at least one locating pin that fixes a mounting position of the bearing support relative to the final drive housing. The locating pin can be formed integrally with the bearing support and integral with the final drive housing. Of course, the locating pin can also be constructed as an additional, separate component part.

If the locating pin is constructed as a separate component part or is formed integral with the final drive housing, it can be advantageous that the bearing support has at least a first recess which serves to receive the locating pin.

When the locating pin is formed integrally with the bearing support or as a separate component part, the drive housing can have at least a second recess for receiving the locating pin.

According to a further advantageous constructional variant of the differential bearing arrangement, the bearing support and the drive housing each have a recess for receiving the locating pin.

In this case, the bearing support and the final drive housing are oriented to one another such that the first recess of the bearing support and the second recess of the final drive housing overlap one another and such that the separately formed locating pin is arranged inside the two recesses and accordingly fixes the position of the bearing support with respect to the final drive housing.

### BRIEF DESCRIPTION OF THE DRAWINGS

The invention will now be described more fully referring to the following figures.

The drawings show:

FIG. 1 is a partial sectional view of an axle bracket of a vehicle axle according to the prior art;

FIG. 2 is a perspective view of a differential bearing arrangement according to the prior art; and

FIG. 3 is a perspective view of an exemplary constructional variant of a differential bearing arrangement.

### DETAILED DESCRIPTION OF THE PRESENTLY PREFERRED EMBODIMENTS

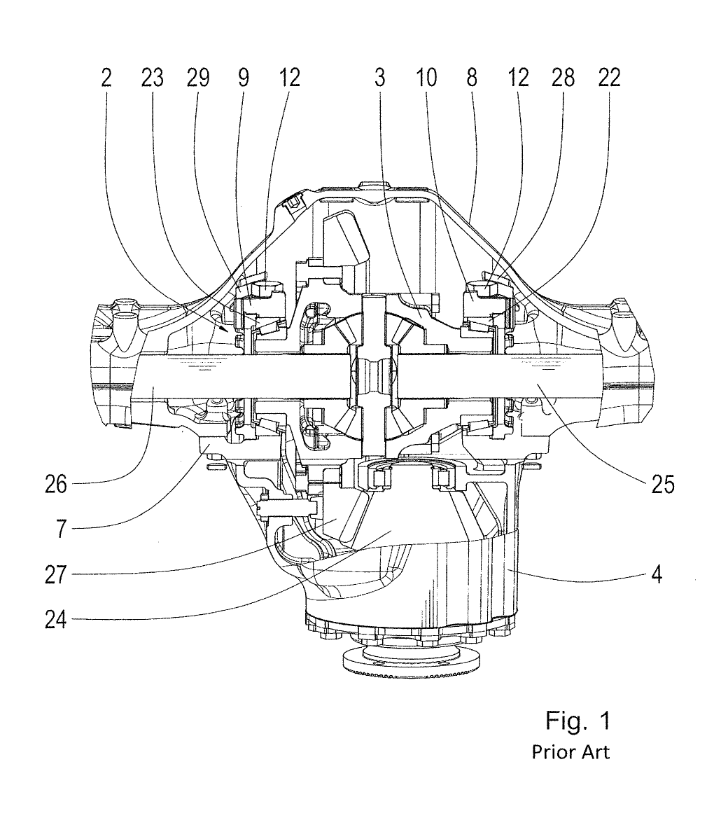

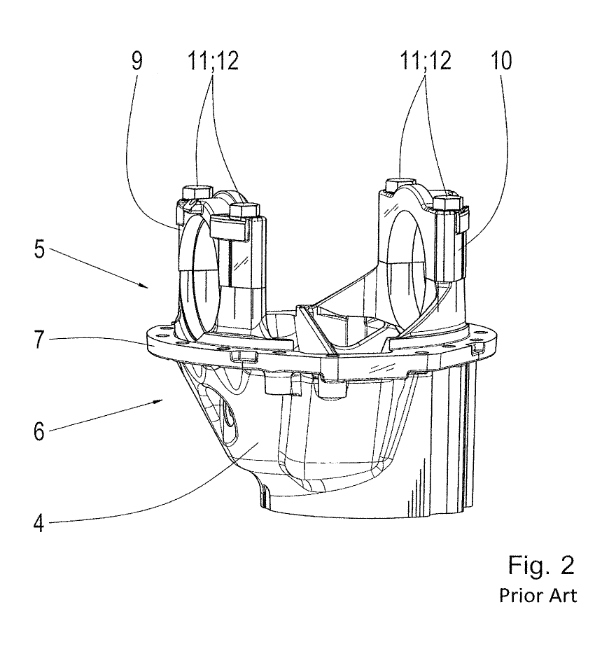

FIG. 1 shows a portion of an axle bracket of a vehicle axle according to the prior art. It comprises a differential bearing arrangement 2 that supports a differential cage 3 indirectly via bearing supports 9; 10 inside the axle bracket housing. The final drive housing 4 comprises a first portion 5 and a second portion 6. The two portions are separated from one another by a fastening collar 7. The first portion 5 is arranged inside the axle bracket such that the fastening collar 7 abuts the surface of the axle bracket 8 and is screwed to the latter. The second portion 6 of the final drive housing 4 is arranged outside of the axle bracket. Further, a bearing support 9 and a bearing support 10 are disposed inside the axle bracket 8 and are arranged at the first portion of the final drive housing 4 and fixedly connected to it by fastening screws 11. Each fastening screw 11 is arranged such that their respective screw head 12 abuts the bearing support 9. This fastening variant of the bearing support 9 at the final drive housing 4 is shown in more detail in FIG. 2.

The differential cage 3 is held within the axle bracket 8 at least indirectly by the bearing supports 9 and 10. A differential bearing 23, 22, which allows a rotation of the differential cage, is arranged in each instance between the bearing supports 9, 10 and the differential cage 3. A drive element 24, which meshes with a crown gear 27, is arranged inside the second portion of the final drive housing, the crown gear 27 being fixedly connected to the differential cage 3. Further, the axle bracket 8 has a first driven element 25 and a second driven element 26 that are set in rotation through the operation of the differential and drive further component parts of the axle bracket and of the vehicle.

FIG. 1 shows that the differential bearing arrangement 2 received inside the axle bracket is supported by an inner wall of the axle bracket 8 in that the bearing support 9 and the screw heads 12 of the fastening screws 11 are supported at a first contact portion 28 and at a second contact portion 29. Contact portions 28 and 29 are formed at the inner wall of the axle bracket 8. It is clearly shown that an installation space must be provided within the axle bracket for the screw heads 12 according to the construction shown in FIG. 1.

FIG. 2 shows the final drive housing 4 with the differential bearing arrangement 2 arranged in the first portion of the drive housing. This differential bearing arrangement 2 comprises a bearing support 9 and 10, the latter being fixedly connected to the drive housing by a fastening screw 11 in each instance. The fastening screws 11 are arranged such that the screw head abuts bearing support 9 and the screw body extends inside bearing support 9 in a bore hole up to the final drive housing 4 and is screwed to the latter. FIG. 2 is an enlarged view showing the differential bearing arrangement 2 according to the prior art which was already shown in a smaller view in FIG. 1.

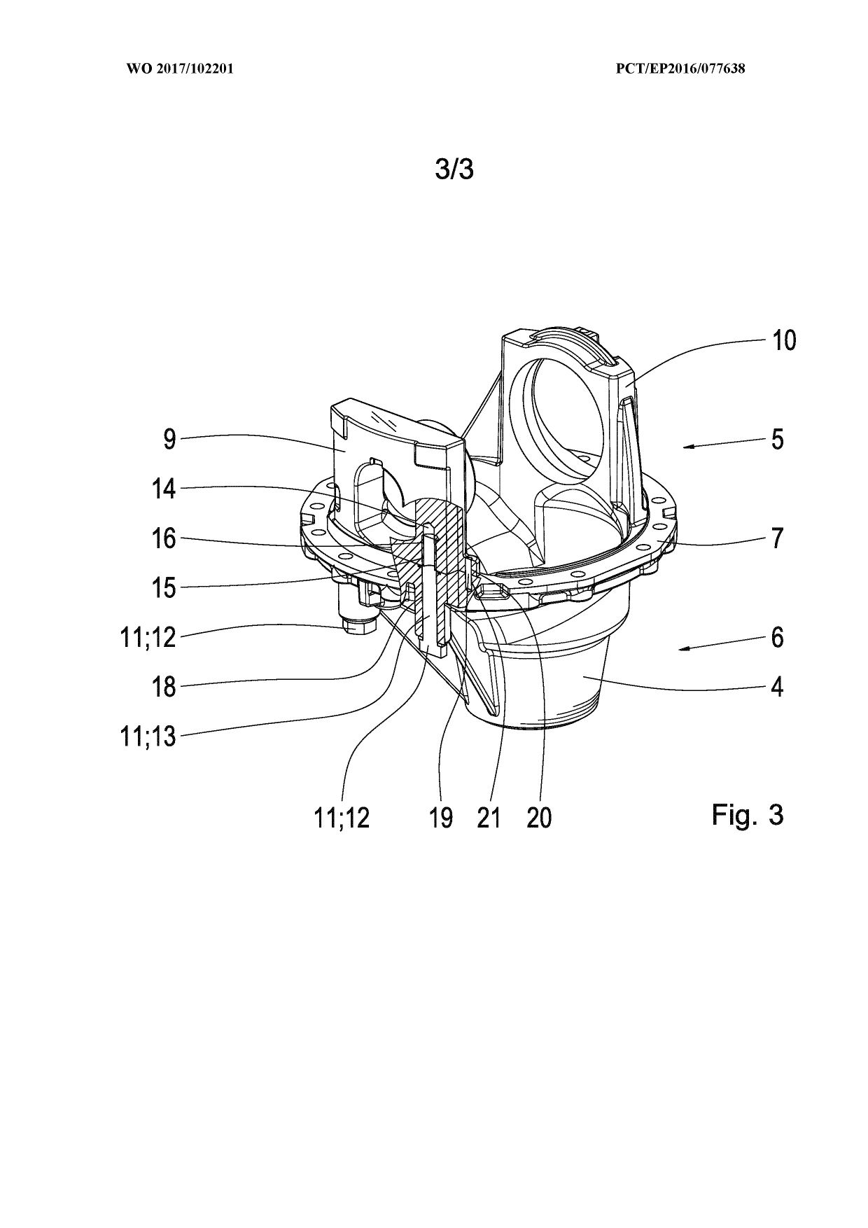

FIG. 3 shows an exemplary constructional variant of the differential bearing arrangement 2. This differential bearing arrangement 2 comprises a final drive housing 4 with a first portion 5 and a second portion 6, these two portions being separated from one another by a fastening collar 7. The fastening collar 7 serves to fasten the final drive housing and the entire differential bearing arrangement 2 and the axle bracket 8 of a vehicle axle.

The differential bearing arrangement 2 shown in FIG. 3 comprises at least one bearing support 9 and 10 for at least indirectly receiving a differential cage 3, the bearing supports 9, 10 being arranged at the first portion 5 at the final drive housing. Bearing support 9 is fixedly connected to the final drive housing 4 by two fastening screws 11. Bearing support 9 comprises a blind hole 14 that has an internal thread 16 formed therein. The fastening screw 11 comprises a screw head 12 and a screw body 13. The cylindrical screw body 13 is provided at least partially with an external thread 15. The fastening screws 11 are arranged such that the screw head 12 thereof abuts an outer surface 17 of the second portion 6 of the final drive housing 4. In doing so, the screw body 13 extends through a through-recess 18 formed in the final drive housing 4 and which connects the first portion 5 to the second portion 6 of the final drive housing 4, and the screw body 13 is received at least partially by a blind hole 14 formed in bearing support 9. In so doing, the internal thread 16 of the blind hole 14 cooperates with the external thread 15 of the fastening screw 11.

To facilitate the positioning of the bearing support 9 with respect to the final drive housing 4, the differential bearing arrangement 2 has at least one locating pin 19. In the constructional variant depicted in FIG. 3, the bearing support 9 has at least one first recess 20 for receiving the locating pin 19. The final drive housing has a second recess 21 for receiving the locating pin 19. The bearing support 9 and the final drive housing 4 are oriented to one another such that the first recess 20 of bearing support 9 and the second recess 21 of final drive housing 4 overlap one another. The locating pin 19 is arranged inside the two recesses 20, 21.

1.-5. (canceled)

6. A differential bearing arrangement for supporting a differential cage, comprising:
a final drive housing having an outer surface;
at least one bearing support;
at least one fastening screw with a screw head and a cylindrical screw body which is at least partially provided with an external thread configured to fixedly connect the at least one bearing support to the final drive housing, wherein the at least one fastening screw is arranged such that the screw head comes to bear against the outer surface of the final drive housing; and
a blind hole with an internal thread formed in the at least one bearing support that cooperates with the external thread of the at least one fastening screw; and
a through-recess formed in the final drive housing through which the cylindrical screw body extends and is at least partially received by the blind hole.

7. The differential bearing arrangement according to claim 6, wherein the differential bearing arrangement comprises at least one locating pin configured to fix a mounting position of the at least one bearing support relative to the final drive housing.

8. The differential bearing arrangement according to claim 7, wherein the at least one bearing support has at least a first recess configured to receive the at least one locating pin.

9. The differential bearing arrangement according to claim 7, wherein the final drive housing has at least a second recess configured to receive the at least one locating pin.

10. The differential bearing arrangement according to claim 7, wherein the at least one bearing support and the final drive housing are oriented to one another such that a first recess of the at least one bearing support and a second recess of the final drive housing overlap one another, and the at least one locating pin is arranged inside the first recess and the second recess.
